(19) United States
(12) Patent Application Publication
(10) Pub. No.: US 2005/0108478 A1
(43) Pub. Date: May 19, 2005

(54) Dynamic frequent instruction line cache

(75) Inventors: Lane Thomas Holloway, Pflugerville, TX (US); Nadeem Malik, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/713,725

(22) Filed: Nov. 13, 2003

(51) Int. Cl. G06F 12/00

(52) U.S. Cl. 711/119; 711/165; 711/137

(57) ABSTRACT

A cache system for a computer. In a preferred embodiment, a DFI-cache (Dynamic Frequent Instruction cache) is queried simultaneously with a main cache, and if a requested address is in either cache, a hit results. The DFI-cache retains frequently used instructions longer than the main cache, so that the main cache can invalidate lines while still enjoying the benefits of a cache hit when next accessing that line.

### BACKGROUND OF THE INVENTION

1. Technical Field

The present invention relates generally to computer memory, and particularly to computer cache for storing frequently accessed lines.

2. Description of Related Art

Cache refers to an upper level memory used in computers. When selecting memory systems, designers typically must balance performance and speed with cost and other limitations. In order to create the most effective machines possible, multiple types of memory are typically implemented.

In most computer systems, the processor is more likely to request information that has recently been requested. Cache memory, which is faster but smaller than main memory, is used to store instructions used by the processor so that when an address line that is stored in cache is requested, the cache can present the information to the processor faster than if the information must be retrieved from main memory. Hence, cache memories improve performance.

Cache performance is becoming increasingly important in computer systems. Cache hits, which occur when a requested line is held in cache and therefore need not be fetched from main memory, save time and resources in a computer system. Several types of cache have therefore been developed in order to increase the likelihood of consistent cache hits and to reduce misses as much as possible.

Several types of cache have been used in prior art systems. Instruction caches (I-caches) exploit the temporal and spatial locality of storage to permit instruction fetches to be serviced without incurring the delay associated with accessing the instructions from the main memory. However, cache lines that are used frequently, but spaced apart temporally or spatially, may still be evicted from a cache depending on the associativity and size of the cache. On a cache miss, the processor incurs the penalty of fetching the line from main memory, thus reducing the overall performance.

Therefore, it would be advantageous to have a method and apparatus that allows lines to continue to be cached based on the frequency of their use can potentially increase the overall hit rates of cache memories.

### SUMMARY OF THE INVENTION

In an example of a preferred embodiment, a cache system for a computer system is provided with a first cache for storing a first plurality of instructions, a second cache for storing a second plurality of instructions, wherein each instruction in the first cache has an associated counter that is incremented when the instruction is accessed. In this embodiment, when the counter reaches a threshold, the related instruction is copied from the first cache into the second cache, where it will be maintained and not overwritten for a longer period than its storage in the first cache.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a block diagram of a computer system consistent with implementing a preferred embodiment of the present invention.

FIG. 2 shows a diagram of components to an example computer system consistent with implementing a preferred embodiment of the present invention.

FIG. 3 shows a cache system according to a preferred embodiment of the present invention.

FIG. 4 shows a flowchart of process steps consistent with implementing a preferred embodiment of the present invention.

FIG. 5 shows a flowchart of process steps consistent with implementing a preferred embodiment of the present invention.

FIG. 6 shows a hardware counter stack consistent with a preferred embodiment of the present invention.

FIG. 7 shows a hardware counter stack consistent with a preferred embodiment of the present invention.

### DETAILED DESCRIPTION OF THE PREFERRED EMBODIMENT

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

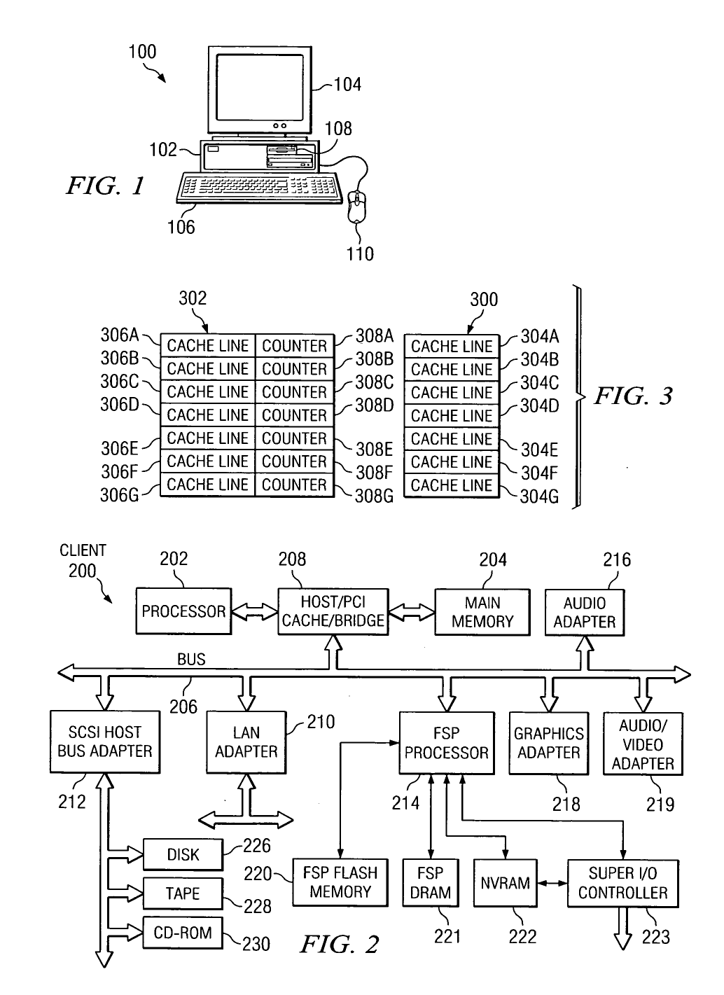

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention teaches an innovative cache system for a computer system, for example, the system shown in FIGS. 1 and 2. In preferred embodiments, the cache of the present invention is implemented, for example, as part of main memory 204, or other cache memory.

In an example of a preferred embodiment, a Dynamic Frequent Instruction cache (DFI-cache) is implemented with a main cache, for example, an instruction cache (I-cache). Both caches are queried simultaneously, so that if a line is held in either cache, the query will result in a hit.

In one embodiment, the each line in the main cache is outfitted with an associated counter that increments whenever that address line is accessed. When the counter reaches a certain number, the line is removed from cache and placed in the DFI-cache. The DFI-cache thereby holds more frequently accessed lines longer than main cache.

In another embodiment, the main cache is supplemented with a hardware counter that counts most referenced lines. When an item is to be eliminated from the main cache, the highest counter value determines which line is removed. The removed line is preferably moved into a DFI-cache, so that more frequently accessed lines remain in cache longer.

FIG. 3 shows a cache architecture of a computer system, consistent with a preferred embodiment of the present invention. In this illustrative example, two caches are depicted, first cache 302 (such as an instruction cache or I-cache) and Dynamic Frequent Instruction (DFI) cache 300. First cache 302 of this example includes space for counters 308A-C that correspond to each line 306A-C of the I-cache 302. Each line 306A-C is outfitted with one such counter of counters 308A-C, and as a line, such as line 306A, is accessed, its counter 308A is increased. It should be noted that though this illustrative example makes reference to an I-cache as the first cache, other types of cache can be implemented in its place, such as victim cache as described by N. P. Jouppi in “Improving Direct-Mapped Cache Performance by the Addition of a Small Fully-Associative Cache and Prefetch Buffers,” published in IEEE, CH2887-8/9/90, and hereby incorporated by reference.

When a counter reaches a predetermined threshold (or a variable threshold, depending on implementation), the line is removed from I-cache 302 and placed in DFI-cache 300, for example, line 304A. In this example, the DFI-cache is fully associative and follows a LRU (Least Recently Used) policy for determining which line to overwrite when a new line is to be added.

The DFI-cache is an additional cache that stores instruction lines that have been determined to be frequent, for example,-by the associated counter reaching a threshold. In the above example, the I-cache and DFI-cache are preferably queried simultaneously. If the sought instruction is in either the DFI-cache or the I-cache, a hit results. The DFI will be updated when an instruction is determined to be frequent.

Though the present invention describes “frequent” instruction lines by the associated counter reaching a threshold, other methods of designating an instruction as “frequent” also can be implemented within the scope of the present invention.

The DFI keeps frequently used lines in cache longer than the normal instruction cache, so that the normal instruction cache can invalidate lines, including lines deemed frequently used lines. When such an instruction is requested again, it is found in the DFI cache, and a hit results. Hence, by the mechanism of the present invention, some cache misses are turned into hits. When a line is found in the DPI-cache only, that line may be retained only in the DFI-cache, or it may be deleted from the DFI-cache and copied into the main cache, or it could be kept in DFI-cache and copied into the main cache. In preferred embodiments, frequency of accessed lines in the DFI-cache is also measured by using a counter. For example, an algorithm that keeps track of the last “X” accesses can be used, where “X” is a predetermined number. Other methods of keeping track of the frequency of accessed lines in the DFI-cache also can be implemented within the scope of the present invention. The DFI cache can be organized as a direct mapped or set associative cache, and the size is preferably chosen to provide the needed tradeoff between space and performance.

In another illustrative embodiment, not only is a counter, such as counter 308A associated with a frequently used cache line 306A of I-cache 302 incremented when that cache line 306A is accessed, but the counters associated with other cache lines in the I-cache 302 are decremented. When a line is to be replaced in the I-cache, the line with the lowest counter number is chosen to be replaced.

This process allows the DFI cache 300 to hold lines with higher counter values, which are accessed more frequently, to be held longer.

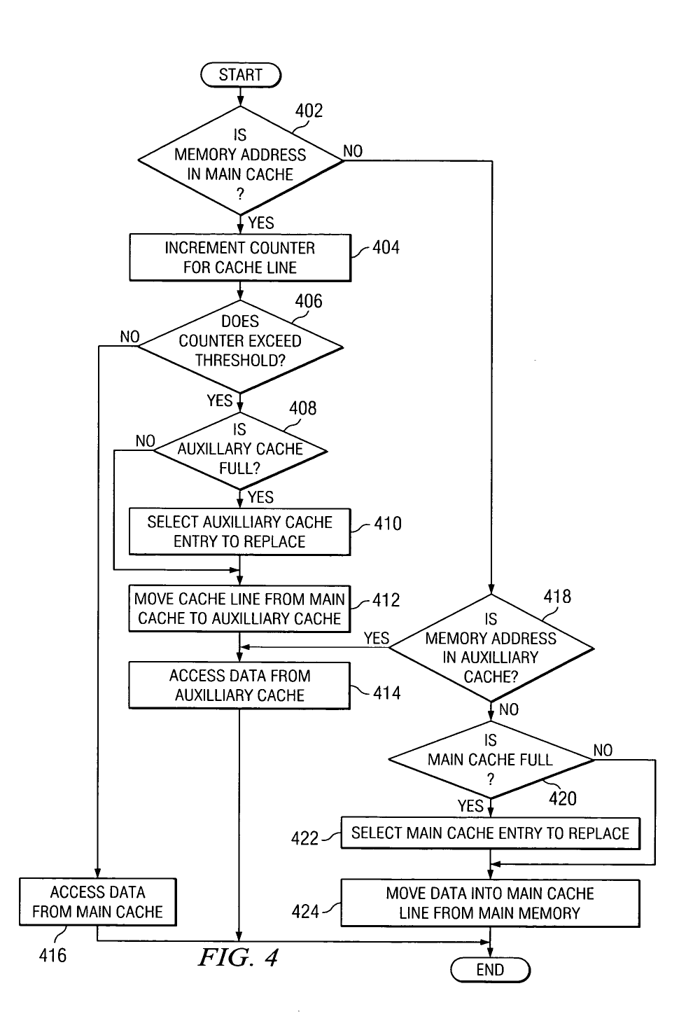

FIG. 4 shows a flowchart for implementing a preferred embodiment of the present invention. In this example process, counters are incremented when a cache hit in main cache occurs, e.g., cache 302. If the counter of a line in the main cache 302 exceeds a threshold, that line is deemed frequent, and the line is moved into the auxiliary cache. In this example, data moved from main cache to auxiliary cache 300 in this way is accessed from the auxiliary cache.

This example process describes a main cache, comparable to cache 302 of FIG. 3, and an auxiliary cache, comparable to DFI-cache 300 of FIG. 3. The process starts with a check to see if a memory address is found in main cache (step 402). If the memory address is found, the counter associated with that cache line is incremented (step 404). If the counter exceeds a threshold (step 406), then the auxiliary cache is checked to see if it is full (step 408). If the counter does not exceed the threshold, then the data is simply accessed from main cache (step 416) and the process ends.

If the counter does exceed the threshold and if the auxiliary cache is full, an entry in the auxiliary cache is selected to be replaced (step 410). If the auxiliary cache is not full, or after an entry in auxiliary cache has been selected to be replaced, the cache line is moved from main cache to auxiliary cache (step 412). Note that this includes removal of the cache line from the main memory. Next, the data is accessed from auxiliary cache (step 414) and the process ends.

If the memory address sought in step 402 is not found in main cache, then the memory address is checked for in auxiliary cache (step 418). If it is found, the process moves to step 414, and the data is accessed from auxiliary cache (step 414). If the memory address is not in auxiliary cache, then the main cache is checked to see if it is full (step 420). If the main cache is full, an entry in main cache is selected to be replaced (step 422) and the data is moved into main cache from the main memory of the computer system (step 424), and the process ends. If the main cache is not full, the data is moved from main memory into the main cache (step 424) and the process ends.

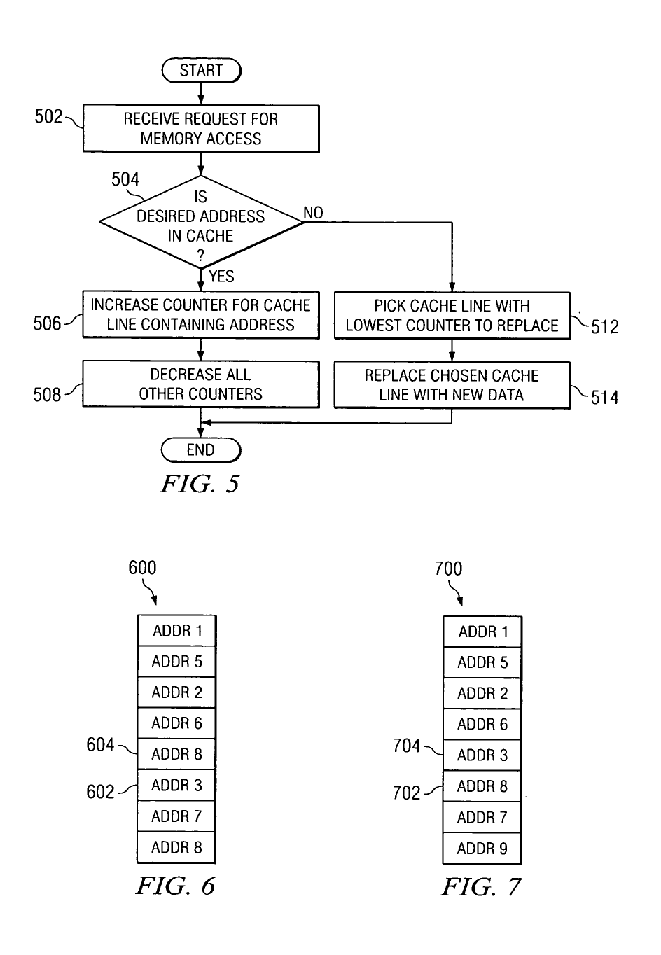

FIG. 5 shows another-process flow for implementing a preferred embodiment of the present invention. In this example, the counter 308A for a selected line 306A of cache 302 is incremented, while the counter 308B, 308C, etc. for all other cache lines 306B, 306C, etc. are decremented, when the selected line is found in cache. When replacement of a cache line in the cache is required, the cache line with the lowest counter (hence, the one least frequently accessed) is replaced.

The process starts with a memory request being received at cache (step 502). In this example, the cache described is comparable to main cache 302 of FIG. 3. This cache is preferably equipped with a counter associated with each line or memory address of the cache. If the desired address is in the cache (step 504), the associated counter for that line is increased (step 506). All other counters are also decreased (step 508), and the process ends.

If the desired address is not in the cache (step 504), then the cache line with the lowest counter is chosen to be replaced (step 512). The chosen cache line is then replaced with new data (step 514). The process then ends.

FIGS. 6 and 7 show another implementation of the present invention. In this example, Hardware counter stack 600 shows counters associated with individual address lines, including “Addr 8” 604 and “Addr 3” 602.

In this embodiment, the main cache is the same as described in FIG. 3, except that there is a hardware counter 600 that counts the most referenced lines. As an address line is fetched, it is placed into the hardware counter at the bottom of the stack. As that address line is again accessed, its associated counter increases, and that address line is moved up the stack, so that higher entries in the stack are referenced more times than lower entries in the stack. When the hardware is full of counters for address lines, and when a new address line is referenced, the bottom address line of the stack is chosen to be replaced.

FIG. 6 shows an example case where address 3 602 is below address 8 604 in the stack. In this case, address 3 602 has a lower counter value than address 8 604. As address 3 602 is accessed more times, its counter value increases, eventually surpassing the counter value of address 8 604. FIG. 7 shows their relative positions after address 3 602 has a higher counter value than address 8 604. In FIG. 7, Address 3 602 appears higher in the stack 600 than address 8 604. In this example, if a new address is referenced, a counter associated with an address is chosen for replacement as described below.

This hardware counter of the present invention is useful, for example, in determining which address from the main cache should be moved into the auxiliary cache, and for determining which line in auxiliary cache (e.g., the DFI-cache) to remove when the cache is full. For example, in one embodiment, main cache is I-cache, and auxiliary cache is DFI-cache. The addresses in I-cache each have a position in hardware counter 600. When I-cache is full and must add another address line, it must expel an address line to make room. The determination as to which line in I-cache to expel (and preferably to write into DFI-cache) is made with reference to hardware counter 600. In preferred embodiments, the most frequently accessed lines are removed from I-cache, i.e., those appearing highest in the hardware counter stack 600. In this example, if a new address were to be added, it would be added at the bottom of the stack, while address 1 would be removed entirely from the I-cache and placed in the DFI-cache. When an item is removed from I-cache, it is also removed from the counter 600.

In another embodiment, each line in the DFI-cache has a counter associated with it. When a line in the DFI-cache is hit, the values of counters associated with the other lines in the DFI-cache are decremented. Thus, more frequently used lines in the DFI-cache have a higher value than less frequently used lines. When a line is to be replaced in the DFI-cache, the line with the lowest counter number is replaced. In this way, the DFI-cache holes frequently used lines longer than the I-cache.

When removing lines form the DFI-cache, other methods can be used to determine what line to remove. In some cases, removing the line with the least hits may be undesirable or inefficient. Known algorithms for page replacement can be implemented in the context of the present invention, such as a working set replacement algorithm. Such an algorithm uses a moving window in time, and pages or lines not referred to in the specified time are removed from the working set or cache.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A cache system for a computer system, comprising:
a first cache for storing a first plurality of instructions;
a second cache for storing a second plurality of instructions;
wherein each instruction of the first plurality has an associated counter, and wherein when a first instruction of the first plurality is accessed, a first associated counter is incremented; and
wherein when the first associated counter reaches a threshold, the first instruction of the first plurality is copied into the second cache.

2. The cache system of claim 1, wherein each instruction of the second plurality has an associated counter, and wherein when an instruction of the second plurality is accessed, all other counters of the first plurality are decremented.

3. The cache system of claim 1, wherein the first instruction of the first plurality is accessed from the second cache.

4. The cache system of claim 1, wherein the associated counters comprise hardware counters, wherein:
when an instruction is fetched, it is placed into the hardware counter at the bottom of a stack of the hardware counter;
wherein when the instruction is accessed again, it is moved up in the stack; and
wherein when the stack is full and a new instruction is stored in the stack, the new instruction replaces the bottom-most address in the hardware counter.

5. The cache system of claim 1, wherein the first cache is an instruction cache and the second cache is fully associative and follows a least recently used policy.

6. A method of managing cache in a computer system, comprising the steps of:
checking for a first instruction in a first cache, wherein each instruction in the first cache has an associated counter;
if the first instruction is found in the first cache, incrementing a first associated counter;
comparing a value of the first associated counter to a threshold;
if the first associated counter exceeds the threshold, moving the first instruction from the first cache to a second cache.

7. The method of claim 6, further comprising the step of:
accessing the first instruction from the second cache.

8. The method of claim 6, wherein each instruction of the second cache has an associated counter, and wherein when an instruction of the second cache is accessed, all other counters of the second cache are decremented.

9. The method of claim 6, wherein the associated counters comprise hardware counters, wherein:
when an instruction is fetched, it is placed into the hardware counter at the bottom of a stack of the hardware counter;
wherein when the instruction is accessed again, it is moved up in the stack; and
wherein when the stack is full and a new instruction is stored in the stack, the new instruction replaces the bottom-most address in the hardware counter.

10. The method of claim 6, wherein the first cache is an instruction cache and the second cache is fully associative and follows a least recently used policy.

11. A computer program product in a computer readable medium, comprising:
first instructions for checking for a first line of data in a first cache, wherein each line of data in the first cache has an associated counter;
second instructions for, if the first line of data is found in the first cache, incrementing a first associated counter;
third instructions for comparing a value of the first associated counter to a threshold;
fourth instructions for, if the first associated counter exceeds the threshold, moving the first line of data from the first cache to a second cache.

12. The computer program product of claim 11, further comprising the step of:
accessing the first instruction from the second cache.

13. The computer program product of claim 11, wherein each instruction of the second cache has an associated counter, and wherein when an instruction of the second cache is accessed, all other counters of the second cache are decremented.

14. The computer program product of claim 11, wherein the associated counters comprise hardware counters, wherein:
when an instruction is fetched, it is placed into the hardware counter at the bottom of a stack of the hardware counter;
wherein when the instruction is accessed again, it is moved up in the stack; and
wherein when the stack is full and a new instruction is stored in the stack, the new instruction replaces the bottom-most address in the hardware counter.

15. The computer program product of claim 11, wherein the first cache is an instruction cache and the second cache is fully associative and follows a least recently used policy.
